(19) United States
(12) Patent Application Publication
(10) Pub. No.: US 2010/0159751 A1
(43) Pub. Date: Jun. 24, 2010

(54) USB CONNECTOR AND CONTACT ARRAY THEREOF

(75) Inventors: Wen-Ta CHIU, HSI CHIH CITY (TW); Ming-Hui YEN, HSI CHIH CITY (TW); Yeh-Shi LIN, HSI CHIH CITY (TW); Chao-Yang HSIAO, HSI CHIH CITY (TW); Jhih-Ming TU, HSI CHIH CITY (TW); Chang-Fa YANG, HSI CHIH CITY (TW); Ping-Chih CHEN, HSI CHIH CITY (TW)

Correspondence Address: BRIAN M. MCINNIS, 12th Floor, Ruttonjee House, 11 Duddell Street, Hong Kong, HK

(73) Assignee: CHANT SINCERE CO., LTD., TAIPEI HSIEN (TW)

(21) Appl. No.: 12/622,444

(22) Filed: Nov. 20, 2009

(30) Foreign Application Priority Data
Dec. 19, 2008 (TW) 97149822

(51) Int. Cl. H01R 24/00

(52) U.S. Cl. 439/660

(57) ABSTRACT

Disclosed herein is a contact array of a universal serial bus (USB) connector including a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

### RELATED APPLICATIONS

This application claims priority to Taiwan Application Serial Number 97149822, filed Dec. 19, 2008, which is herein incorporated by reference.

### BACKGROUND

1. Field of Invention

The present invention relates to an electrical connector. More particularly, the present invention relates to a universal serial bus (USB) connector.

2. Description of Related Art

Universal serial bus (USB) is one of the most popular interfaces in signal transferring among computer devices. The USB interface has upgraded from USB 1.0/1.1 specifications to a USB 2.0 specification, then further to a USB 3.0 specification. Interface upgrading usually involves increasing transferring speed and frequency up to a higher level, and the USB 3.0 connector still has to be compatible with the connector of USB 2.0 and USB 1.0/1.1 specifications. How to overcome the potential cross talks in high-speed and high-frequency signal transferring is a major issue confronted by all connector manufacturers.

### SUMMARY

According one aspect of this invention, a contact array of a universal serial bus (USB) connector includes a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

According another aspect of this invention, a contact array of a universal serial bus (BUS) connector includes a plurality of contacts each comprising a middle section, a first terminal section and a second terminal section. The middle section is interconnected between the first terminal section and second terminal section. A first bent section is interconnected between the first terminal section and the middle section, and a second bent portion is interconnected between the second terminal section and the middle section. The contacts include a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

According to still another aspect of this invention, a universal serial bus (USB) connector includes a metallic housing, a dielectric base and a plurality of contacts. The dielectric base is disposed within the metallic housing and includes a plurality of grooves spaced apart from one another. Each contact is disposed respectively within the plurality of grooves. The contacts include a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

According to yet another aspect of this invention, a contact array of a universal serial bus (USB) connector includes a first signal differential pair, a second signal differential pair and a third signal differential pair. The signal differential pairs each conclude a terminal section, to which a printed circuit board is connected, wherein the terminal sections of the signal differential pairs are arranged as below. The second signal differential pair is disposed between the first and third signal differential pairs, and at least one power contact or ground contact is disposed between the first and second signal differential pairs, or between the second and third signal differential pairs.

Thus, the contact array's arrangements of the USB connector's plug or receptacle would improve signal transferring efficiency and reduce cross talks among the array contacts, which is especially important for high-speed, high-frequency signal transferring of USB 3.0 specification in connection with a printed circuit board.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a USB connector plug according to one embodiment of this invention;

FIG. 2 illustrates a front view of the USB connector plug as illustrated in FIG. 1;

FIG. 3 illustrates the USB connector plug as illustrated in FIG. 1 with its housing removed;

FIG. 4 illustrates a top view of the USB connector plug as illustrated in FIG. 3;

FIG. 5 illustrates the USB connector plug as illustrated in FIG. 4 with its contacts connected to a circuit board's solder pads;

FIG. 6 illustrates a contact array of the USB connector plug according to one embodiment of this invention;

FIG. 7 illustrates a side view of the contact array as illustrated in FIG. 6;

FIG. 8 illustrates a contact array of the USB connector plug according to another embodiment of this invention;

FIG. 9 illustrates a side view of the contact array as illustrated in FIG. 8;

FIG. 10 illustrates a contact array of the USB connector plug according to still another embodiment of this invention;

FIG. 11 illustrates a side view of the contact array as illustrated in FIG. 10;

FIG. 12 illustrates a contact array of the USB connector plug according to yet another embodiment of this invention;

FIG. 13 illustrates a side view of the contact array as illustrated in FIG. 12;

FIG. 14 illustrates a contact array of the USB connector receptacle according to one embodiment of this invention;

FIG. 15 illustrates a top view of the contact array as illustrated in FIG. 14 with its contacts connected to a circuit board's solder pads;

FIG. 16 illustrates a front view of the contact array as illustrated in FIG. 14; and

FIG. 17 illustrates a side view of the contact array as illustrated in FIG. 14.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Disclosed herein is an improved universal serial bus (USB) connector with a contact array design modification in order to reduce cross talking caused by high-speed and high-frequency signal transferring.

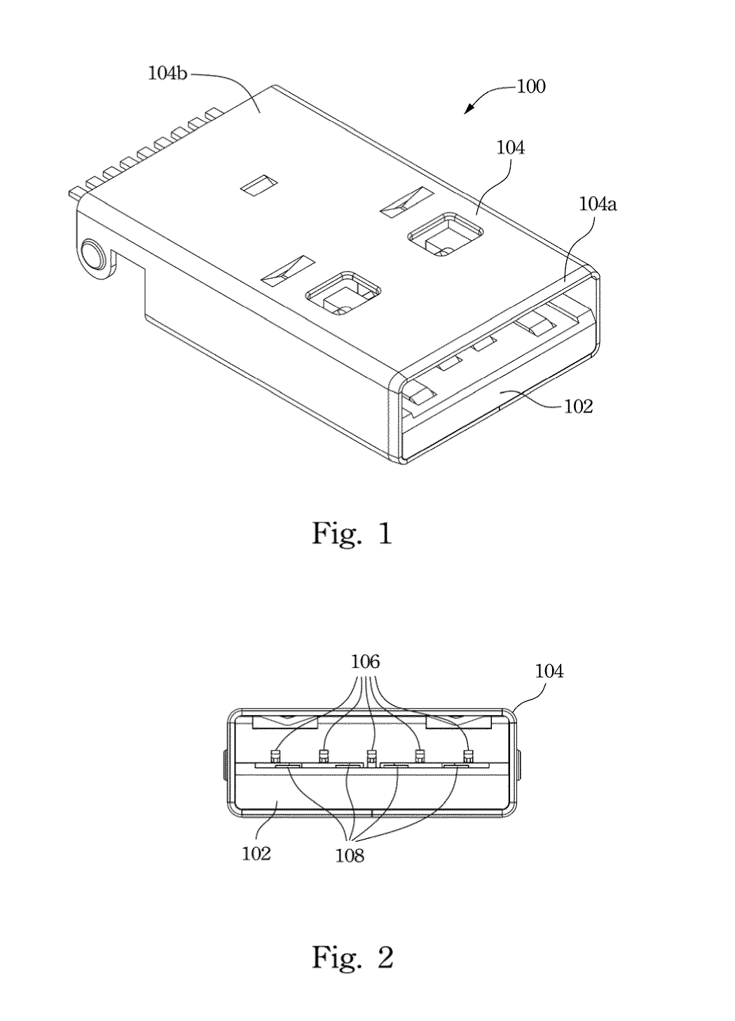

FIG. 1 illustrates a USB connector plug according to one embodiment of this invention. FIG. 2 illustrates a front view of the USB connector plug as illustrated in FIG. 1. The USB connector plug 100 includes a metallic housing 104, a dielectric base 102 and a contact array. When the metallic housing 104 is electrically to the ground, an EMI shielding is hence enabled. The contact array of the USB connector plug 100 includes a USB 2.0 contact array and a USB 3.0 contact array such that the USB connector plug 100 is compatible with a USB 2.0 connector receptacle. In particular, when a front end 104a of the USB connector plug 100 is inserted into the USB 2.0 connector receptacle, the USB 2.0 contact array of the USB connector plug 100 is connected with a contact array of the USB 2.0 connector receptacle. Besides, a rear end 104b of the USB connector plug 100 is connected with a signal cable and wrapped with insulated materials.

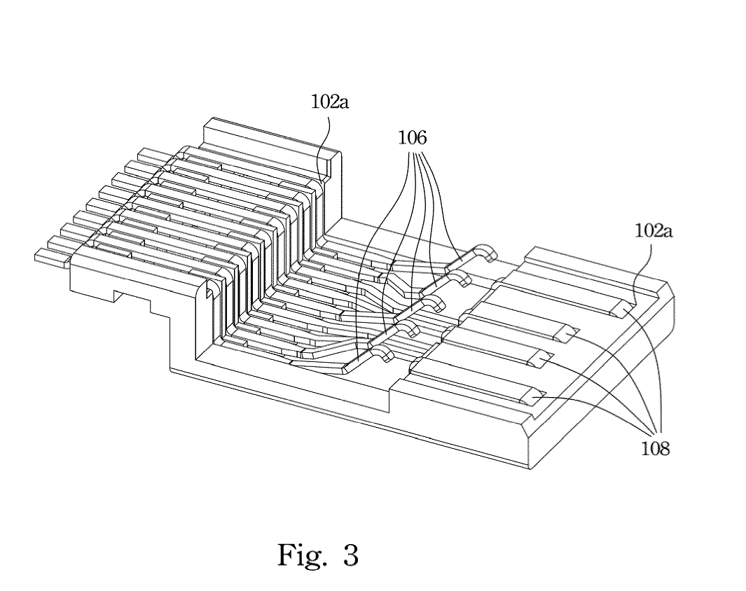

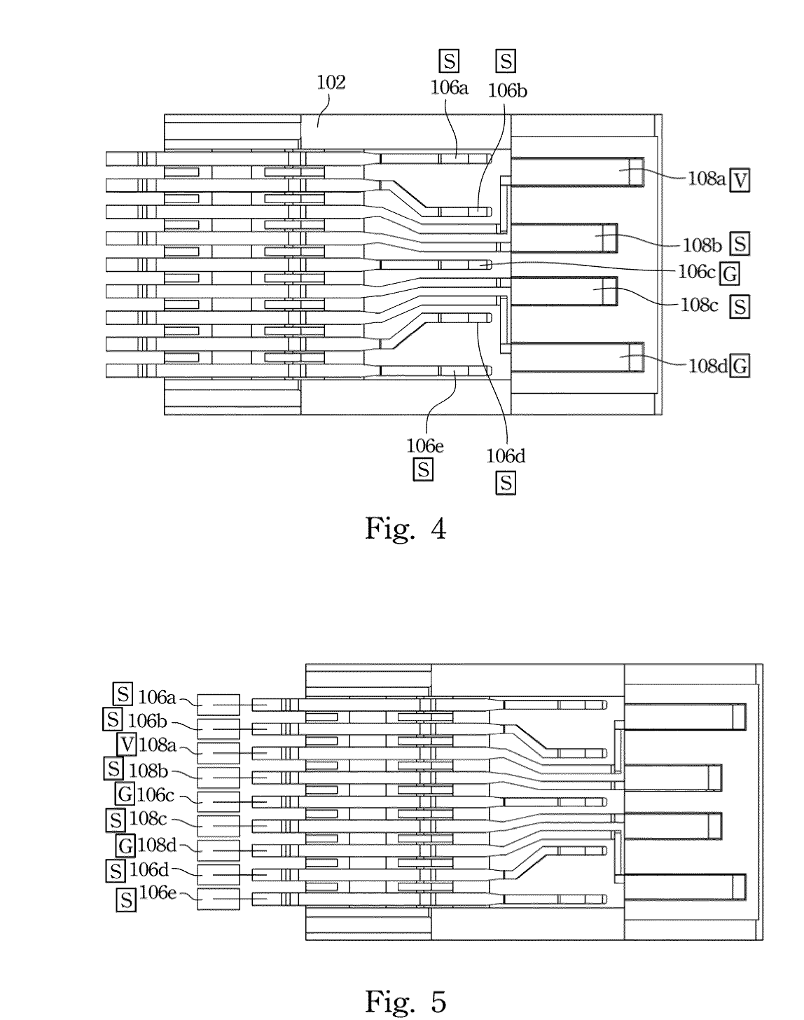

FIG. 3 illustrates the USB connector plug as illustrated in FIG. 1 with its housing removed. FIG. 4 illustrates a top view of the USB connector plug as illustrated in FIG. 3. FIG. 5 illustrates the USB connector plug as illustrated in FIG. 4 with its contacts connected to a circuit board's solder pads. The USB 3.0 contact array includes two signal differential pairs and a ground contact 106c. Signal contacts (106a, 106b) are of one signal differential pair while signal contacts (106d, 106e) are of the other signal differential pair. The USB 2.0 contact array includes a signal differential pair (108b, 108c), a power contact 108a and a ground contact 108d. All the contacts are partially located within their respective grooves 102a of the dielectric base 102 such that they can be electrically insulated from one another. In the drawings of disclosures herein, each signal differential pair (or signal contact) is labeled with [symbol] each power contact is labeled with [symbol] and each ground contact is labeled with [symbol] .

FIG. 5 illustrates the USB connector plug as illustrated in FIG. 4 with its contacts connected to a circuit board's solder pads. The signal differential pair (108b, 108c) is located between the signal differential pair (106a, 106b) and signal differential pair (106d, 106e). The power contact 108a is located between the signal differential pair (106a, 106b) and signal differential pair (108b, 108c). The ground contact 108d is located between the signal differential pair (106d, 106e) and signal differential pair (108b, 108c). From an overview, the contact array is arranged as [symbol] [symbol] along a line.

Referring again to FIG. 5, the USB 3.0 signal differential pair (106a, 106b) has its two signal contacts adjacent to each other, and no power contact or ground contact is located therebetween. The USB 3.0 signal differential pair (106d, 106e) also has its two signal contacts adjacent to each other, and no power contact or ground contact is located therebetween. No power contact or ground contact located between a signal differential pair would reduce cross talks to the least, which is especially important for high-speed signal transferring of USB 3.0 specification.

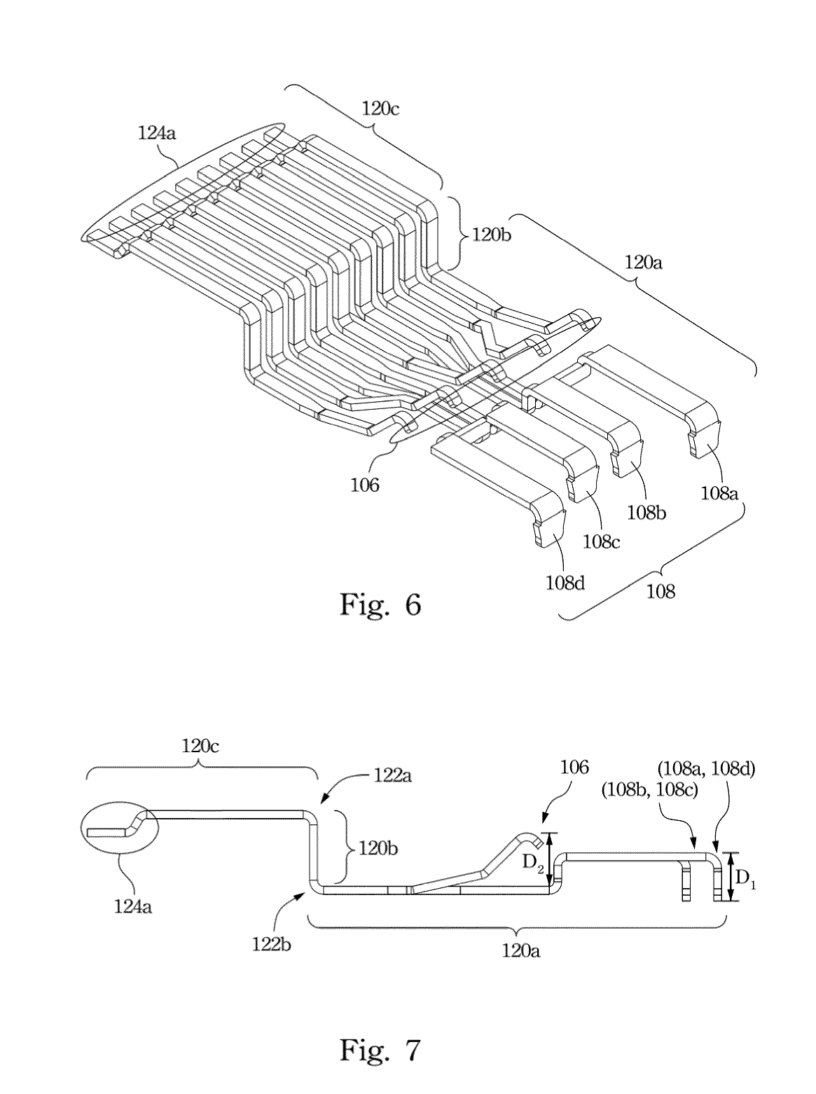

FIG. 6 illustrates a contact array of the USB connector plug according to one embodiment of this invention. FIG. 7 illustrates a side view of the contact array as illustrated in FIG. 6. The contact array, as illustrated in FIG. 6 and FIG. 7, is the USB connector plug of FIG. 3 with the dielectric base 102 removed. Each contact is divided into three sections: a front terminal section 120a, a middle section 120b and a rear terminal section 120c. The middle section 120b is interconnected between the front terminal section 120a and the rear terminal section 120c. The front terminal section 120a is operable to connect with a corresponding USB connector receptacle, whereas the rear terminal section 120c is operable to connect with a printed circuit board. A bent section 122b is interconnected between the middle section 120b and the front terminal section 120a, whereas a bent section 122a is interconnected between the middle section 120b and the rear terminal section 120c.

The rear terminal section 120c of each contact has its end to be connected with a printed circuit board (not illustrated in the drawings). In this embodiment, the end of the rear terminal section 120c is a SMT (Surface Mounting Technology) terminal.

The front terminal section 120a of each contact has its end to be connected with a corresponding USB connector receptacle (not illustrated in the drawings). In order to satisfy USB 3.0 specifications and above-mentioned design requirements, the front terminal section 120a has various bent section designs as discussed below.

Referring both to FIG. 4 and FIG. 6, the front terminal section 120a of the signal contact 106b is bent several times to have its end being closer to the signal differential pair (108b, 108c) than the middle section 120b of the signal contact 106b is. The front terminal section 120a of the signal contact 106d is bent several times to have its end being closer to the signal differential pair (108b, 108c) than the middle section 120b of the signal contact 106d is. The front terminal section 120a of the power contact 108a is bent several times to have its end being farther from the signal differential pair (108b, 108c) than the middle section 120b of the power contact 108a is. The front terminal section 120a of the ground contact 108d is bent several times to have its end being farther from the signal differential pair (108b, 108c) than the middle section 120b of the ground contact 108d is. By the bent designs of the contact array, the end of the front terminal section 120a of the ground contact 108d is located between the ends of the front terminal section 120a of the signal differential pair (106a, 106b) when being viewed from the front terminal section 120a thereof towards the rear terminal section 120c thereof, and the end of the front terminal section 120a of the power contact 108a is located between the ends of the front terminal section 120a of the signal differential pair (106d, 106e) when being viewed from the front terminal section 120a thereof towards the rear terminal section 120c thereof. Therefore, USB 3.0 specification can be satisfied.

Referring again to FIG. 7, the bent sections (122a, 122b) are generally right-angled sections in this embodiment. In an alternate embodiment, the bent sections (122a, 122b) can be otherwise bent, i.e. not right-angled, along a surface profile of the dielectric base 102. Besides, the front terminal section 120a of the contact array 106 is bent upward to have a maximum interval D₁. The front terminal section 120a of the contact array 106 is also bent upward and down to have a maximum interval D₂. Of the contact array 108, the contacts (108a, 108b) are longer than the contacts (108c, 108d).

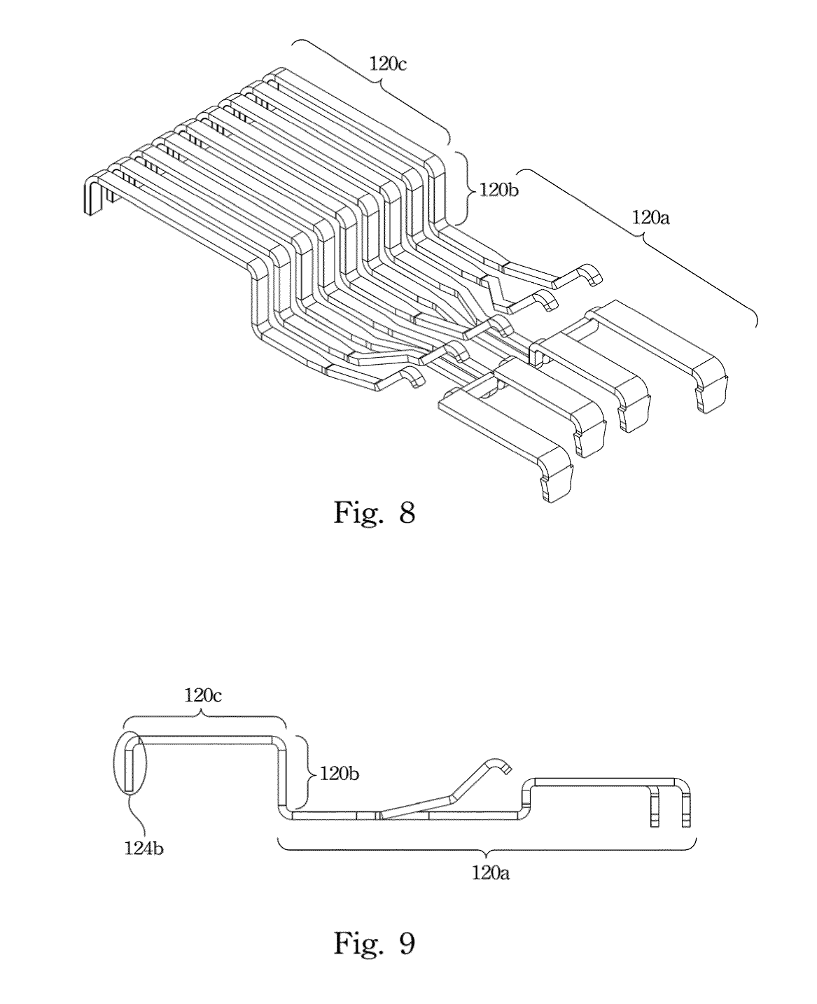

FIG. 8 illustrates a contact array of the USB connector plug according to another embodiment of this invention. FIG. 9 illustrates a side view of the contact array as illustrated in FIG. 8. This embodiment differs from FIG. 6 and FIG. 7 in that the rear terminal section 120c has a different terminal type. In this embodiment, the rear terminal section 120 has a DIP (Dual In-line Package) terminal 124b.

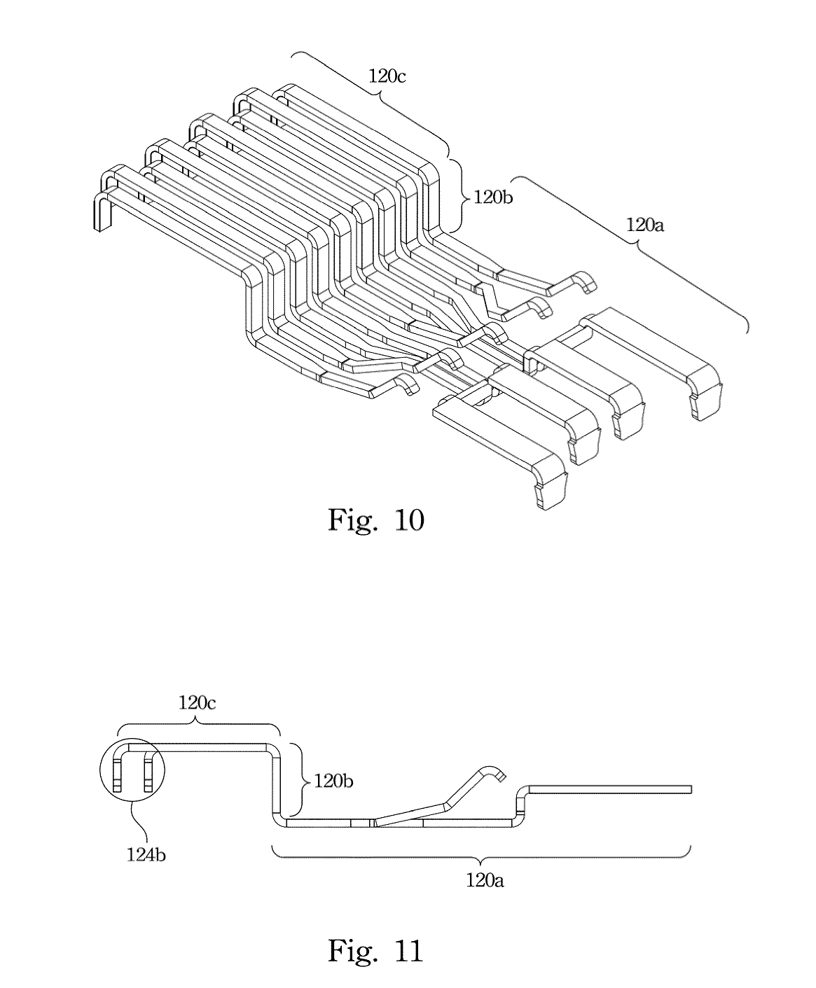

FIG. 10 illustrates a contact array of the USB connector plug according to still another embodiment of this invention. FIG. 11 illustrates a side view of the contact array as illustrated in FIG. 10. This embodiment differs from FIG. 8 and FIG. 9 in that the rear terminal section 120c has a different terminal arrangement. In this embodiment, the rear terminal section 120c has its adjacent DIP terminals 124b of different lengths. When the DIP terminals 124b are soldered to a printed circuit board, adjacent DIP terminals 124b of different lengths would make the interval between solder pads longer such that cross talks can be reduced. The same terminal arrangements can be applied on the embodiments of FIG. 6 and FIG. 7.

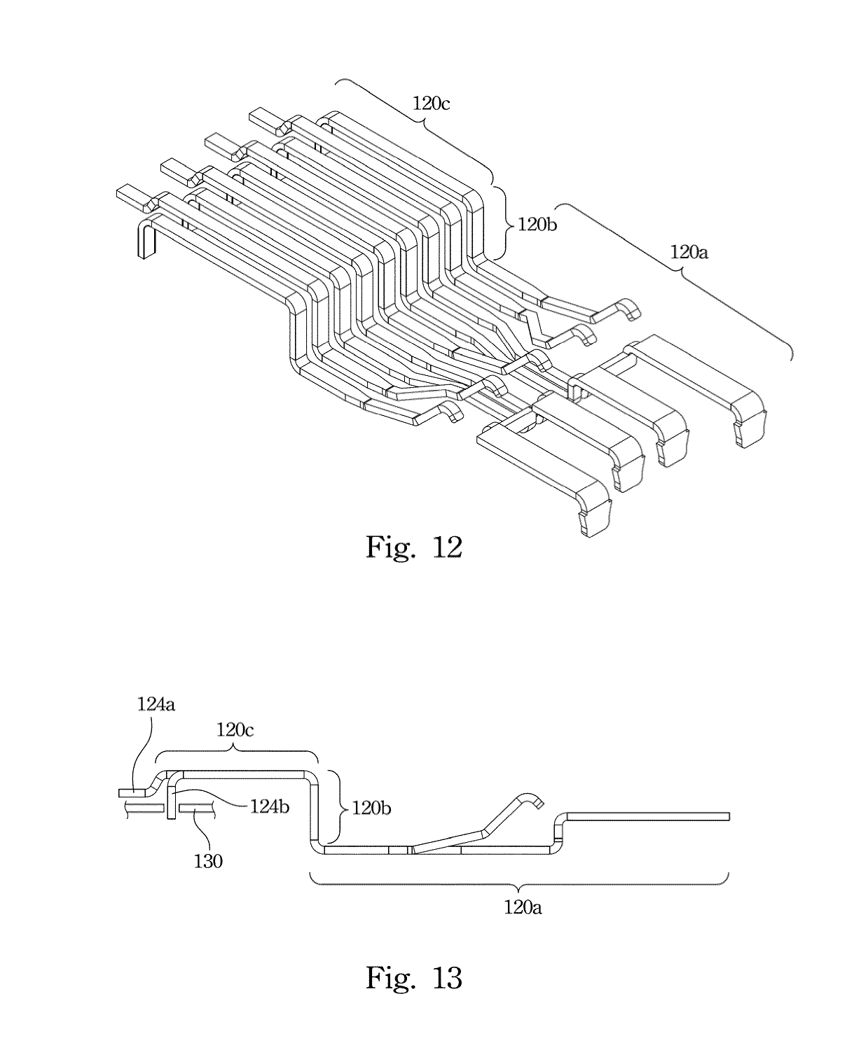

FIG. 12 illustrates a contact array of the USB connector plug according to yet another embodiment of this invention. FIG. 13 illustrates a side view of the contact array as illustrated in FIG. 12. This embodiment differs from the foregoing embodiments in that the rear terminal section 120c has different terminal arrangements and different terminal types. In this embodiment, the SMT terminals 124a and DIP terminals 124b are alternately arranged. The SMT terminals 124a are soldered on a surface of a printed circuit board 130, whereas the DIP terminals I 24b are soldered within a through hole of the printed circuit board 130.

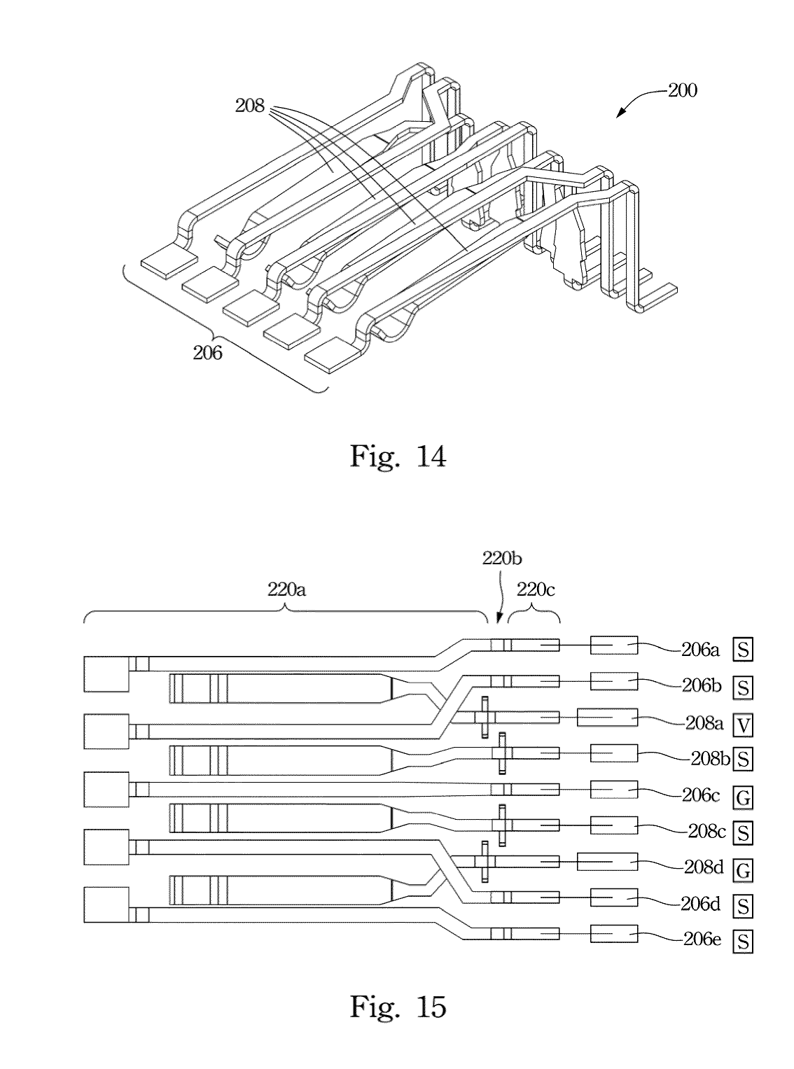

FIG. 14 illustrates a contact array of the USB connector receptacle according to one embodiment of this invention. In order to reduce cross talks among the contact array, the USB connector receptacle has a similar design on the contact array as in the USB connector plug. The contact array 200 includes a USB 2.0 contact array 208 and a USB 3.0 contact array 206 such that the USB connector plug 100 can be compatible with a USB 2.0 connector plug.

FIG. 15 illustrates a top view of the contact array as illustrated in FIG. 14 with its contacts connected to a circuit board's solder pads. The USB 3.0 contact array includes two signal differential pairs and a ground contact 206c. Signal contacts (206a, 206b) are of one signal differential pair while signal contacts (206d, 206e) are of the other signal differential pair. The USB 2.0 contact array includes a signal differential pair (208b, 208c), a power contact 208a and a ground contact 208d.

When the foregoing contact array has its rear terminal section 220c connected with a printed circuit board, the arrangements of the contact array are detailed below. The signal differential pair (208b, 208c) is located between the signal differential pair (206a, 206b) and signal differential pair (206d, 206e). The power contact 208a is located between the signal differential pair (206a, 206b) and the signal differential pair (208b, 208c). The ground contact 208d is located between the signal differential pair (206d, 206e) and the signal differential pair (108b, 108c). From an overview, the contact array is arranged as [symbol] [symbol] along a line.

The USB 3.0 signal differential pair (206a, 206b) has its two signal contacts adjacent to each other, and no power contact or ground contact is located therebetween. The USB 3.0 signal differential pair (206d, 206e) also has its two signal contacts adjacent to each other, and no power contact or ground contact is located therebetween. No power contact or ground contact located between a signal differential pair would reduce cross talks to the least, which is especially important for high-speed signal transferring of USB 3.0 specification.

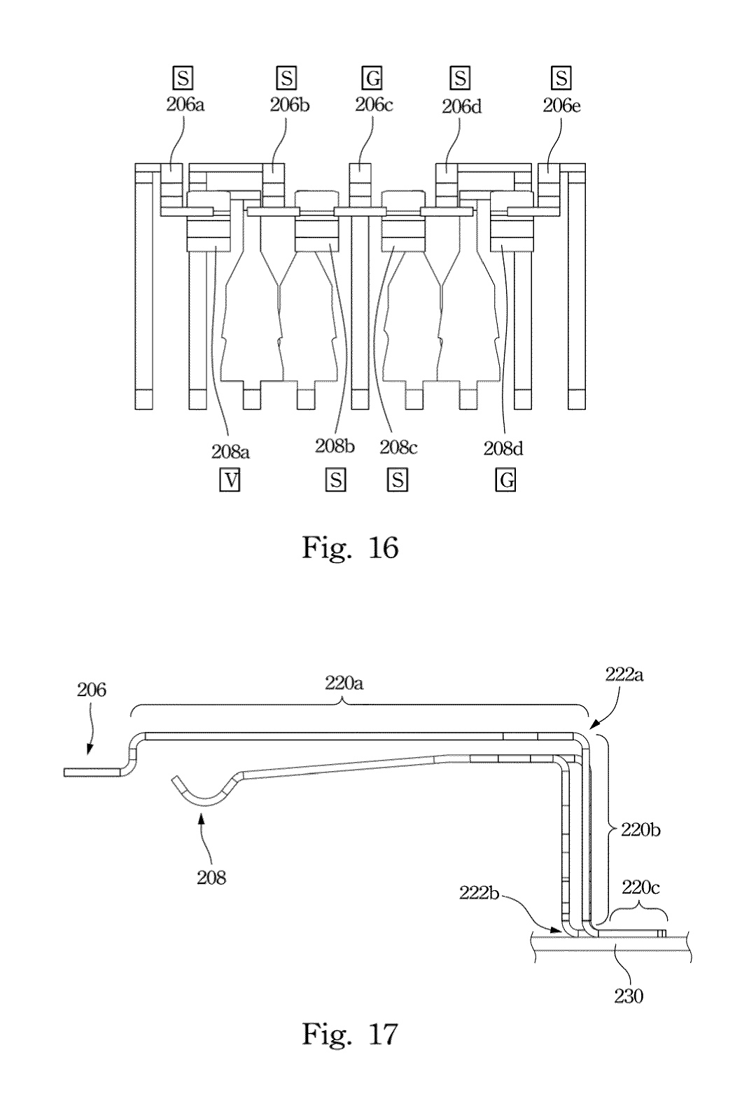

FIG. 16 illustrates a front view of the contact array as illustrated in FIG. 14. FIG. 17 illustrates a side view of the contact array as illustrated in FIG. 14. Each contact is divided into three sections: a front terminal section 220a, a middle section 220b and a rear terminal section 220c. The middle section 220b is interconnected between the front terminal section 220a and the rear terminal section 220c. The front terminal section 220a is operable to connect with a corresponding USB connector plug, whereas the rear terminal section 220c is operable to connect with a printed circuit board 230. A bent section 222a is interconnected between the middle section 220b and the front section 220a, whereas a bent section 222b is interconnected between the middle section 220b and the rear terminal section 220c. In this embodiment, the rear terminal section 220c includes a SMT terminal. In an alternate embodiment, the rear terminal section 220c may include a DIP terminal (as illustrated in FIG. 8), or SMT terminals and DIP terminals arranged alternately (as illustrated in FIG. 12).

The front terminal section 220a of each contact has its end to be connected with a corresponding USB connector plug (not illustrated in the drawings). In order to satisfy USB 3.0 specifications and above-mentioned design requirements, the front terminal section 220a has various bent section designs as discussed below.

Referring both to FIG. 15 and FIG. 17, the front terminal section 220a of the signal contact 206b is bent several times to have its end being closer to the signal differential pair (208b, 208c) than the middle section 220b of the signal contact 206b is. The front terminal section 220a of the signal contact 206d is bent several times to have its end being closer to the signal differential pair (208b, 208c) than the middle section 220b of the signal contact 206d is. The front terminal section 220a of the power contact 208a is bent several times to have its end being farther from the signal differential pair (208b, 208c) than the middle section 220b of the power contact 208a is. The front terminal section 220a of the ground contact 208d is bent several times to have its end being farther from the signal differential pair (208b, 22108c) than the middle section 220b of the ground contact 208d is. Therefore, USB 3.0 specification can be satisfied.

According to foregoing discussed embodiments, the contact array's arrangements of the USB connector's plug or receptacle would improve signal transferring efficiency and reduce cross talks among the array contacts, which is especially important for high-speed, high-frequency signal transferring of USB 3.0 specification in connection with a printed circuit board.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A contact array of a universal serial bus (USB) connector comprising a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

2. The contact array of claim 1, wherein the first and third signal differential pairs are USB 3.0 signal differential pairs.

3. The contact array of claim 2, wherein the second signal differential pair is a USB 2.0 signal differential pair.

4. The contact array of claim 3, further comprising a USB 3.0 ground contact disposed between the second signal differential pair.

5. The contact array of claim 1, wherein the power contact is a USB 2.0 power contact, and the ground contact is a USB 2.0 ground contact.

6. The contact array of claim 5, wherein the first signal differential pair comprises a first signal contact and a second signal contact, the second signal contact is closer to the second signal differential pair than the first signal contact is, the third signal differential pair comprises a third signal contact and a fourth signal contact, the third signal contact is closer to the second signal differential pair than the fourth signal contact is.

7. The contact array of claim 6, wherein each of the signal, power or ground contacts comprises a middle section and two opposite first terminal section and second terminal section, the middle section is interconnected between the first terminal section and second terminal section, the first terminal section is operable to connect with a corresponding USB connector, the second terminal section is operable to connect with a printed circuit board.

8. The contact array of claim 7, wherein the first terminal section of the second signal contact is bent to have an end thereof closer to the second differential pair than the middle section of the second signal contact is, the first terminal section of the third signal contact is bent to have an end thereof closer to the second differential pair than the middle section of the third signal contact is.

9. The contact array of claim 8, wherein the first terminal section of the USB 2.0 power contact is bent to have an end thereof farther from the second differential pair than the middle section of the USB 2.0 power contact is, the first terminal section of the USB 2.0 ground contact is bent to have an end thereof farther from the second differential pair than the middle section of the USB 2.0 ground contact is.

10. The contact array of claim 9, wherein the end of the first terminal section of the USB 2.0 ground contact is disposed between the ends of the first terminal section of the first and second signal contacts when being viewed from the first terminal section thereof towards the second terminal section thereof, and the end of the first terminal section of the USB 2.0 power contact is disposed between the ends of the first terminal section of the third and fourth signal contacts when being viewed from the first terminal section thereof towards the second terminal section thereof.

11. A contact array of a universal serial bus (BUS) connector comprising:
a plurality of contacts each comprising a middle section, a first terminal section and a second terminal section, the middle section being interconnected between the first terminal section and second terminal section, a first bent section being interconnected between the first terminal section and the middle section, a second bent portion being interconnected between the second terminal section and the middle section, wherein the contacts comprises:
a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

12. The contact array of claim 11, wherein the first bent section is generally a right-angled section, and the second bent section is generally a right-angled section.

13. The contact array of claim 11, wherein the first terminal section is operable to connect with a corresponding USB connector, the second terminal section is operable to connect with a printed circuit board.

14. The contact array of claim 13, wherein the second terminal section of the contacts comprises SMT terminals.

15. The contact array of claim 13, wherein the second terminal section of the contacts comprises DIP terminals.

16. The contact array of claim 13, wherein the second terminal section of the contacts comprises SMT terminals and DIP terminals.

17. The contact array of claim 16, wherein the SMT terminals and DIP terminals are alternately arranged.

18. A universal serial bus (USB) connector comprising:
a metallic housing;
a dielectric base disposed within the metallic housing and comprising a plurality of grooves spaced apart from one another; and
a plurality of contacts each disposed respectively within the plurality of grooves, wherein the contacts comprises:
a first signal differential pair, a second signal differential pair and a third signal differential pair, wherein the second signal differential pair is disposed between the first and third signal differential pairs, and at least one power contact or ground contact is disposed between the first and second signal differential pairs, or between the second and third signal differential pairs.

19. A contact array of a universal serial bus (USB) connector comprising a first signal differential pair, a second signal differential pair and a third signal differential pair, the signal differential pairs each comprising a terminal section, to which a printed circuit board is connected, wherein the terminal sections of the signal differential pairs comprises are arranged as:
the second signal differential pair is disposed between the first and third signal differential pairs, and at least one power contact or ground contact is disposed between the first and second signal differential pairs, or between the second and third signal differential pairs.

20. The contact array of claim 19, wherein the first signal differential pair comprises a first signal contact and a second signal contact, the second signal contact is closer to the second signal differential pair than the first signal contact is, the third signal differential pair comprises a third signal contact and a fourth signal contact, the third signal contact is closer to the second signal differential pair than the fourth signal contact is.
